(19) United States
(12) Patent Application Publication
(10) Pub. No.: US 2026/0244318 A1
(43) Pub. Date: Aug. 20, 2026

(54) DYNAMIC DECK OF DEMONSTRATION MODULE CARDS

(71) Applicant: Consensus Sales, LLC, Atlanta, GA (US)

(72) Inventors: Codin Chiritescu, Cottonwood Heights, UT (US); Scott Fisher, South Jordan, UT (US); Brian Zurcher, St. George, UT (US); Cory Crouch, Taylorsville, UT (US)

(21) Appl. No.: 19/546,190

(22) Filed: Feb. 20, 2026

Related U.S. Application Data
(60) Provisional application No. 63/761,055, filed on Feb. 20, 2025.

(51) Int. Cl. G06F 3/0484; G06F 9/451

(52) U.S. Cl. CPC G06F 3/0484; G06F 9/453

(57) ABSTRACT

A system may determine, by one or more processors, a set of module cards in a demo deck based on a first configuration for a first user. A system may determine, by the one or more processors, a set of features including a feature for each of the set of module cards, the set of features including at least one digital demonstration. A system may provide, by the one or more processors, a graphical interface depicting the set of module cards. A system may receive, by the one or more processors, a first input from the first user interacting with a first module card of the set of module cards. A system may update, by the one or more processors, the graphical interface of the set of module cards based on the first input including modifying a graphical depiction of a second module card of the set of module cards.

### BACKGROUND

This application relates to the curation of online demonstrations. For example, technologies described in this application may allow administrative users to guide a user experience on a client device of a user with whom the online demonstration and associated tools are displayed.

A digital demonstration of a computer program or other product may include media and/or a reproduction of the program or product. Unfortunately, typically, where multiple demonstrations are shared, they are shared individually. In these and other instances, the non-guided sharing of demonstrations or other software modules leads to substantial consumption of computing resources, not to mention confusion by the receiving user.

### SUMMARY

A system for providing a dynamic deck of demonstration module cards can be configured to perform particular operations or actions by virtue of having software, firmware, hardware, or a combination of them installed on the system that in operation causes or cause the system to perform the actions.

In some aspects, the techniques described herein relate to a computer-implemented method including: determining, by one or more processors, a set of module cards in a demo deck based on a first configuration for a first user; determining, by the one or more processors, a set of features including a feature for each of the set of module cards, the set of features including at least one digital demonstration; providing, by the one or more processors, a graphical interface depicting the set of module cards; receiving, by the one or more processors, a first input from the first user interacting with a first module card of the set of module cards; and updating, by the one or more processors, the graphical interface of the set of module cards based on the first input including modifying a graphical depiction of a second module card of the set of module cards.

In some aspects, the techniques described herein relate to a computer-implemented method, wherein updating the graphical interface of the set of module cards includes: changing a status of the graphical depiction of the second module card of the set of module cards from hidden to visible; and allowing interaction with the second module card by the first user.

In some aspects, the techniques described herein relate to a computer-implemented method, further including: determining, by the one or more processors, a condition for enabling access to a third module card to the first user, the condition being defined by a second user; and based on determining the condition for enabling access to the third module card, displaying the third module card in the graphical interface to the first user.

In some aspects, the techniques described herein relate to a computer-implemented method, wherein: the first input from the first user interacting with first module card includes an interaction with a defined demonstration element of the at least one digital demonstration accessed via the first module card; and based on the interaction with the defined demonstration element, providing, by the one or more processors, functionality of the second module card in the graphical interface.

In some aspects, the techniques described herein relate to a computer-implemented method, wherein: the at least one digital demonstration includes a plurality of graphical demonstration elements organized into a sequence of steps, the first user interacting with the plurality of graphical demonstration elements during the at least one digital demonstration, the one or more processors tracking progress by the first user through the sequence of steps; and the at least one digital demonstration is accessed via the first module card.

In some aspects, the techniques described herein relate to a computer-implemented method, wherein: the first input includes an interaction with a defined graphical demonstration element; and modifying the graphical depiction of the second module card is based on the interaction with the defined graphical demonstration element, modifying the graphical depiction of the second module card changes a visual status of the second module card from hidden to displayed in the graphical interface showing the demo deck.

In some aspects, the techniques described herein relate to a computer-implemented method, further including: receiving, by the one or more processors, a second input from the first user including a second interaction with a second defined graphical demonstration element of the plurality of graphical demonstration elements; and updating, by the one or more processors, the graphical interface of the set of module cards based on the second input including changing a visual status of a third module card of the set of module cards from hidden to displayed in the graphical interface showing the demo deck, the first module card providing access to a first function, the second module card providing access to a second function, and the third module card providing access to a third function.

In some aspects, the techniques described herein relate to a computer-implemented method, further including: receiving, by the one or more processors, a configuration of the demo deck by a second user, the configuration indicating access settings for one or more of the set of module cards; receiving, by the one or more processors, a share request from the second user indicating to share the demo deck with the first user; and providing, by the one or more processors, access to the demo deck by the first user subject to the configured access settings for one or more of the set of module cards.

In some aspects, the techniques described herein relate to a computer-implemented method, further including: receiving, by the one or more processors, a second share request from the second user to share one or more of the demo deck and the at least one digital demonstration with a third user; recording, by the one or more processors, a location of the first user in the graphical interface when receiving the second share request; and providing, by the one or more processors, access to the one or more of the demo deck and the at least one digital demonstration with the third user based on the second share request and the recorded location in the graphical interface.

In some aspects, the techniques described herein relate to a computer-implemented method, wherein: at least one module card of the set of module cards of the demo deck provides a chat interface, the chat interface providing interaction with an artificial intelligence agent including providing information to the artificial intelligence agent describing the at least one digital demonstration.

In some aspects, the techniques described herein relate to a computer-implemented method, wherein: the graphical interface of the set of module cards in the demo deck includes a grid of graphical representations of rectangular cards, each of the grid of graphical representations of rectangular cards providing a different functionality to the first user, each graphical representation of a rectangular card being enabled within the graphical interface based on a defined trigger.

In some aspects, the techniques described herein relate to a system including: one or more processors; and a computer accessible memory storing instructions that, when executed by the one or more processors, cause the system to perform operations including: determining, by the one or more processors, a set of module cards in a demo deck based on a first configuration for a first user; determining, by the one or more processors, a set of features including a feature for each of the set of module cards, the set of features including at least one digital demonstration; providing, by the one or more processors, a graphical interface depicting the set of module cards; receiving, by the one or more processors, a first input from the first user interacting with a first module card of the set of module cards; and updating, by the one or more processors, the graphical interface of the set of module cards based on the first input including modifying a graphical depiction of a second module card of the set of module cards.

In some aspects, the techniques described herein relate to a system, wherein updating the graphical interface of the set of module cards includes: changing a status of the graphical depiction of the second module card of the set of module cards from hidden to visible; and allowing interaction with the second module card by the first user.

In some aspects, the techniques described herein relate to a system, wherein the operations further include: determining, by the one or more processors, a condition for enabling access to a third module card to the first user, the condition being defined by a second user; and based on determining the condition for enabling access to the third module card, displaying the third module card in the graphical interface to the first user.

In some aspects, the techniques described herein relate to a system, wherein: the first input from the first user interacting with first module card includes an interaction with a defined demonstration element of the at least one digital demonstration accessed via the first module card; and based on the interaction with the defined demonstration element, providing, by the one or more processors, functionality of the second module card in the graphical interface.

In some aspects, the techniques described herein relate to a system, wherein: the at least one digital demonstration includes a plurality of graphical demonstration elements organized into a sequence of steps, the first user interacting with the plurality of graphical demonstration elements during the at least one digital demonstration, the one or more processors tracking progress by the first user through the sequence of steps; and the at least one digital demonstration is accessed via the first module card.

In some aspects, the techniques described herein relate to a system, wherein: the first input includes an interaction with a defined graphical demonstration element; and modifying the graphical depiction of the second module card is based on the interaction with the defined graphical demonstration element, modifying the graphical depiction of the second module card changes a visual status of the second module card from hidden to displayed in the graphical interface showing the demo deck.

In some aspects, the techniques described herein relate to a system, wherein the operations further include: receiving, by the one or more processors, a second input from the first user including a second interaction with a second defined graphical demonstration element of the plurality of graphical demonstration elements; and updating, by the one or more processors, the graphical interface of the set of module cards based on the second input including changing a visual status of a third module card of the set of module cards from hidden to displayed in the graphical interface showing the demo deck, the first module card providing access to a first function, the second module card providing access to a second function, and the third module card providing access to a third function.

In some aspects, the techniques described herein relate to a system, wherein the operations further include: receiving, by the one or more processors, a configuration of the demo deck by a second user, the configuration indicating access settings for one or more of the set of module cards; receiving, by the one or more processors, a share request from the second user indicating to share the demo deck with the first user; and providing, by the one or more processors, access to the demo deck by the first user subject to the configured access settings for one or more of the set of module cards.

In some aspects, the techniques described herein relate to a system, wherein the operations further include: receiving, by the one or more processors, a second share request from the second user to share one or more of the demo deck and the at least one digital demonstration with a third user; recording, by the one or more processors, a location of the first user in the graphical interface when receiving the second share request; and providing, by the one or more processors, access to the one or more of the demo deck and the at least one digital demonstration with the third user based on the second share request and the recorded location in the graphical interface.

Other implementations of one or more of these aspects include corresponding systems, apparatus, and computer programs, configured to perform the actions of the methods, encoded on computer storage devices.

It should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram of an example system for providing intelligent webpage screen capture and demo generation.

FIG. 2 is a block diagram of an example computing system.

FIGS. 3A and 3B illustrate a flowchart of example methods for providing a dynamic deck of demonstration module cards.

FIG. 4 illustrates an example login interface.

FIGS. 5-8 illustrate example interfaces for selecting topics for one or more digital demonstrations.

FIG. 9 illustrates an example graphical interface including example initial demo deck showing two example cards.

FIGS. 10-11 illustrate a graphical interface including an example demo deck in which additional cards have been released and are displayed to the second user.

FIG. 12 illustrates an example interface with a card displaying information and links for contacting the first user.

FIG. 13 illustrates an example AI chat interface.

FIGS. 14-16 illustrate a graphical interface including a card showing a demo with a demo player.

FIG. 17 illustrates an example interface in which a media region is shown alongside a sidebar.

FIG. 18 illustrates an example interface in which the demo deck manager may surface a chat interface with the first user and/or an AI chatbot.

FIGS. 19 and 20 illustrate example interfaces including an example demo player.

FIG. 20 illustrates an example interface including an example demo player.

FIG. 21 illustrates an example interface for sharing a demo deck or digital demonstration.

### DESCRIPTION

The present disclosure relates to systems and methods for intelligently generating, updating, and providing a dynamic deck of digital demonstration (also referred to as a demo herein) module cards (also referred to herein simply as cards) and associated functionality. The demo deck may provide a unified and/or user-specific (e.g., based on the individual, role, and/or organization) navigational architecture or structure for determining, updating, and using functionalities associated with a digital demonstration, such as a demonstration of a product or software displayed on a computer (e.g., in a browser or dedicated application). Beneficially, the technology described herein may allow a semi-guided user interface, in which the system provides guided freedom, such as using context aware tools that are enabled depending on user-role, sharing status, progress through one or more digital demonstrations or tours, sharing user settings, or other contexts.

Implementations of the technology provide a system for controlling a customized digital demonstration and/or associated functionality by a stakeholder, such as an administrator, salesperson, educator, or other user. The digital demonstration may include media (video, audio, etc.), text, and/or interactable elements, which demonstrate some product or feature of a product. For instance, a demo may have elements including videos, executable code, reproductions of functionality, etc., which may be organized into a sequence, grouping, or other set of elements in a demo. Similarly, multiple demos may be organized into a larger structure or presentation for a user.

In some cases, the technology may relate to one or more demonstration presentations that allow interaction with a website, for example, by copying the DOM (Document Object Model) or other HTML of the website to create a mirror or sandboxed copy of the website. In some instances, a copy of a website may use the code or functionality of the website, for example, by re-creation of the functionality through code in the demo. Similarly, the digital demo may include images, videos, etc.

In some implementations, a first user, such as a stakeholder, seller, administrator, etc., may use the technology to dynamically and intelligently build a flow of multiple demos. As a user proceeds through one or more demos, the system may order and/or build a set of multiple demos based on context (e.g., based on which demos or portions of demos are completed, user status, input within individual demos, etc.). A demo deck may include cards representing individual demos and details (e.g., progress, downloads, content, etc.) thereof, so that a user can control their own flow through demos and view their position/progress. The technology may update a demo deck graphical interface as demos are arranged, added, or otherwise interacted with by one or multiple users.

In some implementations, the demo deck or a card in the demo deck may cause a multi-demo board to be displayed where, as a user (e.g., an end user or second user) proceeds through demos, the technology automatically builds a set of multiple demos based on context and/or interactions. This process and display, depending on the instance, may be manually and/or automatically influenced by the first user/shareholder. In some cases, the demo deck graphical interface may also display cards representing individual demos (or sets/paths/sequences of demos), so the second/end user may interact with the cards to control their own flow through multiple demos or sets of demos.

Among other benefits, the graphical user interfaces may be designed to lay out the cards in a container. The container, displayed cards, organization of cards, and/or the card functionality may be customized to the user based on the user ID (e.g., the specific user, role, or user's organization), the context (how far the user has progressed through the demo(s), manual release of features by a first user or administrator, satisfaction of defined criterial, or otherwise), or based on other criteria, such as device type. For instance, the individual cards and/or set of cards may be sized, arranged, or otherwise adapted to match the device type (desktop computer, laptop, tablet, smart phone, XR headset, etc.) and resolution, input devices, or otherwise.

The technology may automatically update the demo deck support container to provide an available set of tools or card modules for a second/end user depending on a first user's configuration, the first user's criteria, or the progression of the second user through the tools and/or demo(s) or the other criteria (e.g., user role, etc., as noted elsewhere herein). Accordingly, the demo deck may be updated based on the end user's understanding, interests, or areas that are most pertinent to them. The layout of the modules/tools/cards in the demo deck container is also particularly helpful for the user to easily navigate, especially when the user is new to a topic or accessing it from a mobile device.

With reference to the figures, reference numbers may be used to refer to components found in any of the figures, regardless of whether those reference numbers are shown in the figure being described. Further, where a reference number includes a letter referring to one of multiple similar components (e.g., component 000a, 000b, and 000n), the reference number may be used without the letter to refer to one or all of the similar components. Further, it should be noted that, while various example features and implementations are described throughout this disclosure and the figures, these examples are not exhaustive of every contemplated implementation, feature or permutation. For instance, while a certain feature may be described in reference to a first implementation, the feature may be used with a second implementation or the features, operations, etc., may otherwise be exchanged between the implementations.

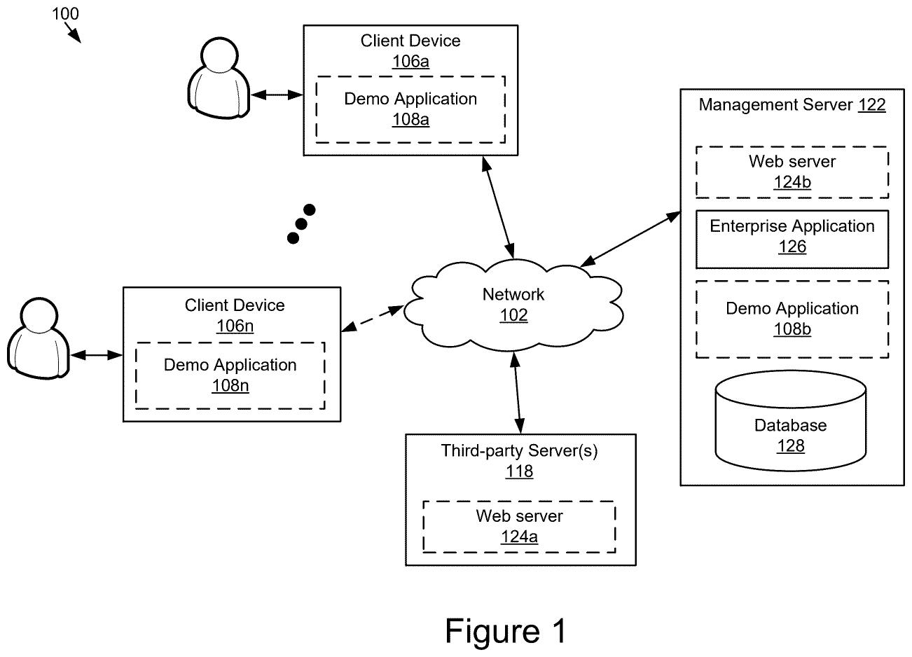

FIG. 1 is a block diagram of an example system 100 for providing intelligent webpage screen capture and demo generation. The demo may also include layered information previewed in customizable cards and multi-layered information in hot spots or other UI elements on a graphical interface. The illustrated system 100 may include one or more client devices 106, a third-party server(s) 118, and/or a management server 122, which may run instances of the demo application 108a, 108b, and 108n and/or which may be electronically communicatively coupled via a network 102 for interaction with one another, although other system configurations are possible including other devices, systems, and networks. For example, the system 100 could include any number of client devices 106, third-party servers 118, management server(s) 122, and other systems and devices.

The network 102 may include any number of networks and/or network types. For example, the network 102 may include, but is not limited to, one or more local area networks (LANs), wide area networks (WANs) (e.g., the Internet), virtual private networks (VPNs), wireless wide area network (WWANs), WiMAX® networks, personal area networks (PANs) (e.g., Bluetooth® communication networks), various combinations thereof, etc. These private and/or public networks may have any number of configurations and/or topologies, and data may be transmitted via the networks using a variety of different communication protocols including, for example, various Internet layer, transport layer, or application layer protocols. For example, data may be transmitted via the networks using TCP/IP, UDP, TCP, HTTP, HTTPS, DASH, RTSP, RTP, RTCP, VOIP, FTP, WS, WAP, SMS, MMS, XMS, IMAP, SMTP, POP, WebDAV, or other known protocols.

The client device(s) 106 (e.g., one or multiple client devices 106 may be used by a single participant, multiple participants, stakeholders, administrators, or by other users) includes one or more computing devices having data processing and communication capabilities. The client device 106 may couple to and communicate with other client devices 106 and the other entities of the system 100 via the network 102 using a wireless and/or wired connection, such as the management server 122. Examples of client devices 106 may include, but are not limited to, mobile phones, wearables, tablets, laptops, desktops, netbooks, server appliances, servers, virtual machines, televisions, XR (extended reality) headsets, etc. The system 100 may include any number of client devices 106, including client devices 106 of the same or different type.

In some implementations, one or multiple client devices 106 may be used with a demo application 108 to execute an instance or component thereof or to otherwise access the demo application 108, for example, via a web server 124.

The management server 122 and its components may aggregate information about and provide data associated with the systems and processes described herein to a multiplicity of users on a multiplicity of client devices 106, for example, as described in reference to various users and client devices 106 described herein. In some implementations, a single user may use more than one client device 106a. . . 106n, which the management server 122 as described above, or multiple users may use multiple client devices 106a. . . 106n to interact with to perform operations described herein. In some implementations, the management server 122 may communicate with and provide information to a client device 106.

The management server 122 may include a web server 124b, an enterprise application 126, a demo application 108, and/or a database 128. In some configurations, the enterprise application 126 and/or demo application 108 may be distributed over the network 102 on disparate devices in disparate locations or may reside at the same location. The client device 106a and/or the management server 122 may each include an instance of the demo application 108 and/or portions/functionalities thereof. The client devices 106 may also store and/or operate other software such as a demo application 108, an operating system, other applications, etc., that are configured to interact with the management server 122 via the network 102.

The management server 122 and/or the third-party server 118 have data processing, storing, and communication capabilities, as discussed elsewhere herein. For example, the servers 118 and/or 122 may include one or more hardware servers, server arrays, storage devices and/or systems, etc. In some implementations, the servers 118 and/or 122 may include one or more virtual servers, which operate in a host server environment.

In some implementations, the enterprise application 126 may receive communications from a client device 106 and/or third-party server 118 in order to perform the functionality described herein. The enterprise application 126 may receive information and provide information to the demo application 108 to generate adaptable graphical interfaces described, as well as perform and provide analytics and other operations. In some implementations, the enterprise application 126 may perform additional operations and communications based on the information received from client devices 106, as described elsewhere herein.

The database 128 may be stored on one or more information sources for storing and providing access to data, such as the data storage device 208. The database 128 may store data describing client devices 106, instances of the demo application 108, media segments, HTML, images, UI elements, tools or module cards, composite data files, metadata, preferences, configurations, and other information, such as described herein.

A third-party server 118 can host services such as a third-party application (not shown) or various webpages, which may be individual and/or incorporated into the services provided by the management server 122 and/or demo application 108. For example, the third-party server 118 may represent one or more item databases, forums, company websites, etc. For instance, a third-party server 118 may provide automatically delivered and processed data, such as frames, attributes, media segments, tools/functionality, and/or services, such as media processing services or other services. In some implementations, the third-party server 118 may provide the content that is being demoed, such as an application or website. In some cases, it may include a web server 124a for serving the content to client device 106 or management server 122, which may, for example, host the demo application 108 (and/or the demo deck manager 232.

In some implementations, one or more of the cards in the demo deck interface may interface with a web server 124a of the third-party server 118 in order to use services provided by that server. For instance, a particular card may interface with the third-party server 118 to use an inter-party chat service provided by the server 118. Similarly, another card in the deck could interface with the same or different third-party server 118 to use different functionality, such as a return-on-investment calculator, artificial intelligence chat, or otherwise. Accordingly, the management server 122 (and/or the demo application 108 directly) may provide functionality that can be enabled or disabled in the demo deck interface with one or multiple internal or external services that are usable within a single interface or accessible via the interface. For example, the management server 112 or demo application 108 may interface with one or more third-party servers 118 via application programming interfaces and present the functionality as an iFrame or otherwise in the demo deck interface. The access or visibility into these tools may be controlled by an administrative or sharing user, progress through a demonstration, user role or organization, or other context.

The demo application 108a . . . 108n and web server 124a . . . 124b, for instance, are described in further detail below. Additionally, while the demo deck manager 232 is described and illustrated below as being a component of the demo application 108, it should be noted that it may be a separate application and/or may interface with the demo application 108. For example, the demo deck manager 232 may be executed on a client device 106, such as on a browser plugin, and it may transmit data or otherwise interface (e.g., via an API) with the demo application 108 (e.g., operating on a management server 122 or otherwise).

It should be understood that the system 100 illustrated in FIG. 1 is representative of an example system and that a variety of different system environments and configurations are contemplated and are within the scope of the present disclosure. For instance, various acts and/or functionality may be moved from a server to a client, or vice versa, data may be consolidated into a single data store or further segmented into additional data stores, and some implementations may include additional or fewer computing devices, services, and/or networks, and may implement various functionality client or server-side. Further, various entities of the system may be integrated into a single computing device or system or divided into additional computing devices or systems, etc.

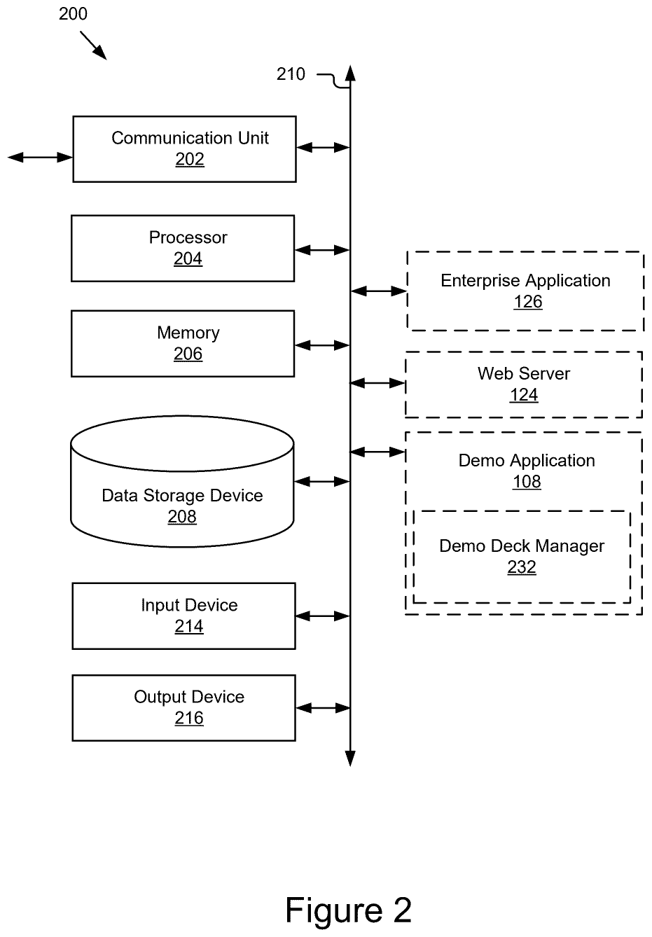

FIG. 2 is a block diagram of an example computing system 200, which may represent computer architecture of a client device 106, third-party server 118, management server 122, and/or another device described herein, depending on the implementation. In some implementations, as depicted in FIG. 2, the computing system 200 may include an enterprise application 126, a web server 124, a demo application 108, demo deck manager 232, and/or another application, code, or device, depending on the configuration. For instance, a client device 106 may include or execute a demo application 108 (which could incorporate various aspects of the enterprise application 126, in some implementations); and the management server 122 may include the web server 124, the enterprise application 126, and/or components thereof, although other configurations are also possible and contemplated.

While the example computing system 200 is presented as an example of an architecture in which some all of the technology described herein may be implemented, it should not be construed as a limiting environment as an appropriate system may be architected in which the physical aspects of the system perform, enable, or improve various functionality, for example, which may be evident or possible in light of the technologies described herein.

The enterprise application 126 may include computer logic executable by the processor 204 to perform operations discussed elsewhere herein. The enterprise application 126 may be coupled to the data storage device 208 to store, retrieve, and/or manipulate data stored therein and may be coupled to the web server 124, the demo application 108, and/or other components of the system 100 to exchange information therewith.

The web server 124 includes computer logic executable by the processor 204 to process content requests (e.g., to or from a client device 106). The web server 124 may include an HTTP server, a REST (representational state transfer) service, or other suitable server type. The web server 124 may receive content requests (e.g., product search requests, HTTP requests) from client devices 106, cooperate with the enterprise application 126 to determine the content, retrieve and incorporate data from the data storage device 208, format the content, and provide the content to the client devices 106.

In some instances, the web server 124 may format the content using a web language and provide the content to a corresponding demo application 108 for processing and/or rendering to the user for display. The web server 124 may be coupled to the data storage device 208 to store retrieve, and/or manipulate data stored therein and may be coupled to the enterprise application 126 to facilitate its operations.

The demo application 108 may include computer logic executable by the processor 204 on a client device 106 to provide for user interaction, receive user input, present information to the user via a display, and send data to and receive data from the other entities of the system 100 via the network 102. In some implementations, the demo application 108 may generate and present user interfaces based on information received from the enterprise application 126, third-party server 118, and/or the web server 124 via the network 102. For example, a stakeholder/user may use the demo application 108 to perform the operations described herein.

In some implementations, a demo deck manager 232 may be included in, with, or separate to the demo application 108. This may be a separate service on a separate device or integrated into the demo application 108. For example, the demo deck manager 232 may perform operations described herein. In some implementations, the demo deck manager 232 may be an extension of a web browser.

As depicted, the computing system 200 may include a processor 204, a memory 206, a communication unit 202, an output device 216, an input device 214, and a data storage device 208, which may be communicatively coupled by a communication bus 210. The computing system 200 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing system 200 may include various operating systems, sensors, additional processors, and other physical configurations. The processor 204, memory 206, communication unit 202, etc., are representative of one or more of these components.

The processor 204 may execute software instructions by performing various input, logical, and/or mathematical operations. The processor 204 may have various computing architectures to method data signals (e.g., CISC, RISC, etc.). The processor 204 may be physical and/or virtual and may include a single core or plurality of processing units and/or cores. In some implementations, the processor 204 may be coupled to the memory 206 via the bus 210 to access data and instructions therefrom and store data therein. The bus 210 may couple the processor 204 to the other components of the computing system 200 including, for example, the memory 206, the communication unit 202, the input device 214, the output device 216, and the data storage device 208.

The memory 206 may store and provide access to data to the other components of the computing system 200. The memory 206 may be included in a single computing device or a plurality of computing devices. In some implementations, the memory 206 may store instructions and/or data that may be executed by the processor 204. For example, the memory 206 may store one or more of the enterprise application 126, the web server 124, the demo application 108, the demo deck manager 232, and/or their respective components, depending on the configuration. The memory 206 is also capable of storing other instructions and data, including, for example, an operating system, hardware drivers, other software applications, databases, etc. The memory 206 may be coupled to the bus 210 for communication with the processor 204 and the other components of computing system 200.

The memory 206 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 204. In some implementations, the memory 206 may include one or more of volatile memory and non-volatile memory (e.g., RAM, ROM, hard disk, optical disk, etc.). It should be understood that the memory 206 may be a single device or may include multiple types of devices and configurations.

The bus 210 can include a communication bus for transferring data between components of a computing device or between computing devices, a network bus system including the network 102 or portions thereof, a processor mesh, a combination thereof, etc. In some implementations, the enterprise application 126, web server 124, demo application 108, and various other components operating on the computing system/device 200 (operating systems, device drivers, etc.) may cooperate and communicate via a communication mechanism included in or implemented in association with the bus 210. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 202 may include one or more interface devices (I/F) for wired and wireless connectivity among the components of the system 100. For instance, the communication unit 202 may include, but is not limited to, various types known connectivity and interface options. The communication unit 202 may be coupled to the other components of the computing system 200 via the bus 210. The communication unit 202 can provide other connections to the network 102 and to other entities of the system 100 using various standard communication protocols.

The input device 214 may include any device for inputting information into the computing system 200. In some implementations, the input device 214 may include one or more peripheral devices. For example, the input device 214 may include a keyboard, a pointing device, a mouse, microphone, an image/video capture device (e.g., camera), a touchscreen display integrated with the output device 216, etc. The output device 216 may be any device capable of outputting information from the computing system 200. The output device 216 may include one or more of a display (LCD, OLED, etc.), a printer, a haptic device, audio reproduction device, touch-screen display, a remote computing device, etc. In some implementations, the output device is a display which may display electronic images and data output by a processor of the computing system 200 for presentation to a user, such as the processor 204 or another dedicated processor.

The data storage device 208 may include one or more information sources for storing and providing access to data. In some implementations, the data storage device 208 may store data associated with a database management system (DBMS) operable on the computing system 200. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

The data stored by the data storage device 208 may be organized and queried using various criteria including any type of data stored by them, such as described herein. For example, the data storage device 208 may store the database 128. The data storage device 208 may include data tables, databases, or other organized collections of data. Examples of the types of data stored by the data storage device 208 may include, but are not limited to, the data described with respect to the figures, for example, the data may include user accounts, media segments, images, demonstration presentations, UI elements, media, topic data, topic cards, module cards, tools, logic, administrative roles, user roles, etc.

The data storage device 208 may be included in the computing system 200 or in another computing system and/or storage system distinct from but coupled to or accessible by the computing system 200. The data storage device 208 can include one or more non-transitory computer-readable mediums for storing the data. In some implementations, the data storage device 208 may be incorporated with the memory 206 or may be distinct therefrom.

The components of the computing system 200 may be communicatively coupled by the bus 210 and/or the processor 204 to one another and/or the other components of the computing system 200. In some implementations, the components may include computer logic (e.g., software logic, hardware logic, etc.) executable by the processor 204 to provide their acts and/or functionality. In any of the foregoing implementations, the components may be adapted for cooperation and communication with the processor 204 and the other components of the computing system 200.

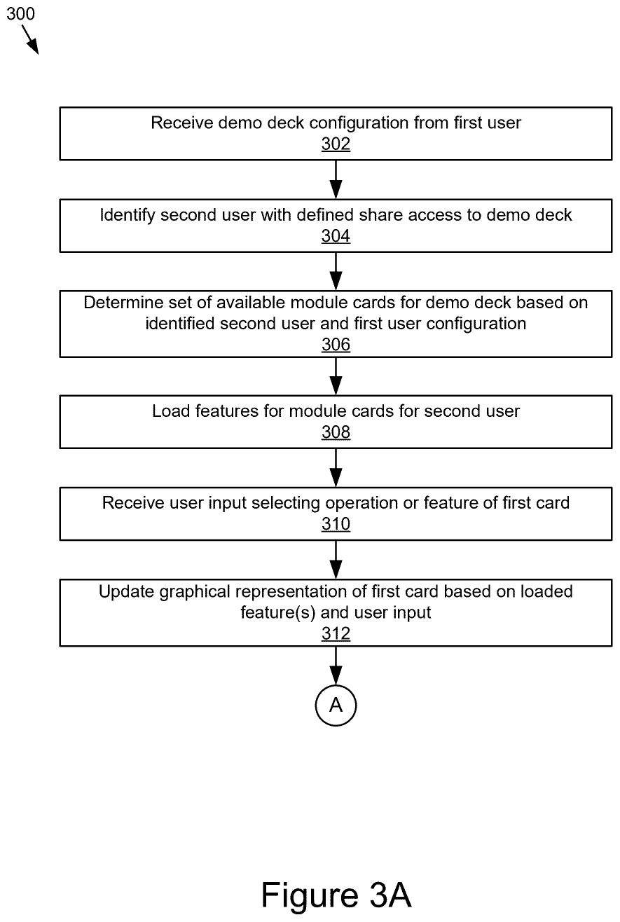

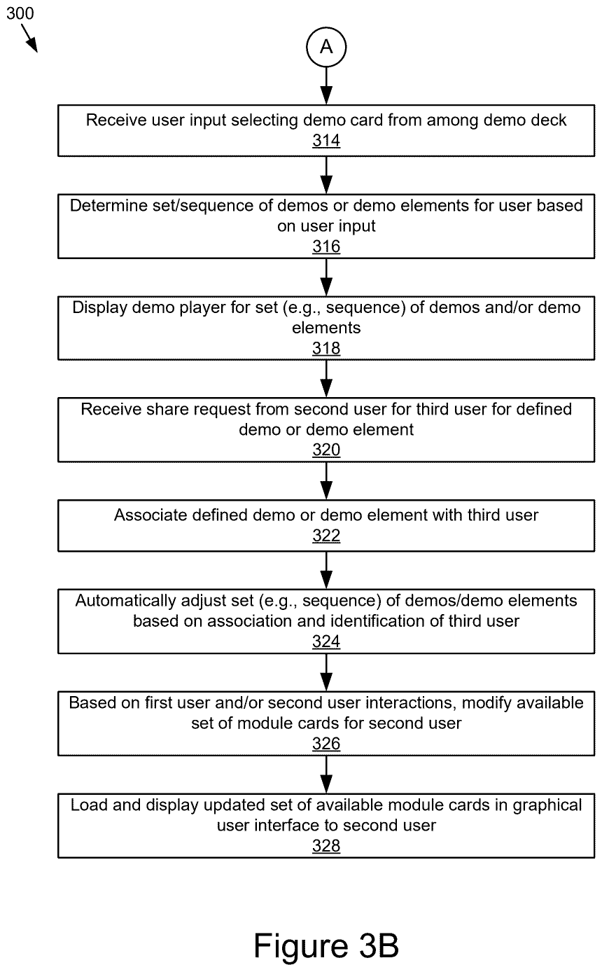

FIGS. 3A-3B illustrate a flowchart of an example method 300 including operations for intelligently generating, updating, and providing a dynamic deck of digital demonstration module cards (also referred to as cards or demo cards herein) and associated functionality. Although certain example operations, sequences, and orders are described, others may be possible, depending on the implementation. For example, certain operations and features may be illustrated and described, they may be omitted, modified, reordered, or additional operations or features may be added.

In some implementations, at 302, the demo deck manager 232 or another component, may receive a configuration of a demo deck and/or of individual cards from first user, such as an administrator, seller, product representative, or other user.

In some implementations, the first user may provide details for one or more second users with whom the demo deck may be shared. The first user may also define roles, such as employee types in an organization for which the demo deck is being prepared/shared. For instance, each role may have a different set, arrangement, or functionality of cards, set or sequences of demos, etc., as noted elsewhere herein. While the definition of details for only a single user, role, or organization are described below, the first user may customize the cards, functionality, demos, or criteria for modifying these aspects to each user, role, or organization, etc.

In some cases, the first user may define a set of cards that are available to the second user initially, later, and/or finally. For example, as noted elsewhere herein, a demo deck card may represent a module or tool that is accessible to the second user. Each card may provide functionality to the second user in a graphical user interface. The set of cards may be laid out in a grid, as illustrated, or they may be laid out in suits (e.g., in groups of types of cards), a carousel, a stacked deck, etc. One or more cards may include demos or sets of demos (e.g., interactive digital user experiences that tour or demonstrate a product or multiple products), one or more cards may include a chat interface (e.g., between the first and second users or with an AI chat bot), one or more cards may include functional tools (e.g., calculators, purchase/ordering interfaces, etc.), or other modules, as noted elsewhere herein.

The first user may define criteria or triggers that change or increase the cards that are available to the user and/or the functionality of each card. For instance, the first user may indicate that once a second user has completely viewed (or interacted with a defined percentage) a first demo card showing a first demo path, a second card for a second demo path should be shown. In another example, when a user has completed a certain amount of a given demo or interacted with certain cards, another card may be displayed allowing the user to purchase or license the underlying product. In yet another example, once a user has interacted with a certain demo element (e.g., describing a product feature), another card may be displayed in which they are able to interact with a demo of that product/feature, or a return on investment (ROI) calculator may be displayed so that the second user can use it to calculate a benefit or feature of the demoed item. While these triggers may be defined by the first user, they may be determined automatically, or the first user may manually release or control them (e.g., with or without tracking of second user interactions). Accordingly, the demo application 108 may determine and use the defined parameters, access levels, or features of a certain card or group of cards when providing functionality and graphical interfaces to a second user. In some cases, these parameters may be set or overridden by a second user with whom the demo card(s) and demo deck are shared.

In some cases, the first user may control (directly or via defined criteria) the functions of individual cards. For instance, the demo deck manager may customize the functionality of one or more of the cards to the second user (e.g., based on first user input). For example, the demo application 108 may configure a first card to provide a demo or path/set/sequence of demos of a certain product or feature of a product. The first user may define which demos are present in the card, their order, or they may be defined using machine learning or otherwise tracking user interests (e.g., whether defined or based on user interactions with cards, demos, demo elements, etc.) against available cards, demos, or demo elements.

For example, the first user or creator of the demo board/deck link may add a curated list of demos for a second user, and s/he may enable specific sets of functionalities in the demo deck based on his/her sales process. For example, the first user may provide an initial set of cards and/or demos based on an initial discovery meeting and then, as the sales process progresses, the first user may interact with the demo application 108 to add cards, which are laid out to the second user in the graphical demo deck via the second user's instance of the demo application 108. Depending on the implementation, the first user's interface may show all, or a filtered or recommended list, of cards and the first user may toggle switches for a user (and/or role, organization, etc.), which the demo deck manager 232 automatically provides on a graphical user interface of the second user, so that the first user effectively guides the experience for each second persona (e.g., so various second users may see have different UX/user experiences based on their progression, role, organization, or first user control).

In some implementations, the first user may also define permissions for the second user, such as whether the second user is allowed to share the demo deck or aspects of it with other users (e.g., a third user) using other instances of the demo application 108.

In some implementations, at 304, the demo deck manager 232 may identify a second user with defined share access to demo deck. For instance, the first user may provide profile or login details, a link, or email that allows the second user to access the demo deck. At this point or, as noted above, the first user may define which aspects, cards, or demos of the demo deck are available to the second user, so that the demo application 108 (e.g., the demo deck manager 232) customizes the demo deck and experience to the second user.

As noted elsewhere herein, the first user may also select a dataset that customizes the demo cards to the second user, such as interfaces, products, images, logos, institutional knowledge, pricing, specific to the second user's organization. For example, the first user may allow an AI chat agent (e.g., powered by a large language model via an application programming interface and retrieval augmented generation) to provide details specific to the demo deck, demos, product, and/or second user's organization.

For instance, during configuration of the demo deck, cards in the demo deck, and/or tours/demos within a card, an administrative user (e.g., the first user), may indicate certain images, data, or databases that serve as templates or placeholders. When the demo deck/demo(s) are generated and/or provided to the first user, second user, or subsequent shares, the demo application 108 may automatically retrieve and place the images, data, or databases in the placeholders (based on user identity, role, or organization), so that the user sees a customized experience. Similarly, the demo application 108 may generate and/or use embeddings of a knowledgebase of materials (e.g., selected by an administrative and/or first/sharing user) to augment chats with a defined artificial intelligence chat bot, for example, using retrieval augmented generation.

In some implementations, at 306, the demo deck manager 232 may determine a set of available module cards for demo deck based on identified second user and first user configuration. For example, based on a link or email from the first user, the second user may log in or create a profile. Based on the identification of the second user, the demo deck manager may identify the available cards along with their respective features, customizations, or functionalities for the second user, as noted above. The demo deck manager may display the available set of cards in a graphical user interface, as noted elsewhere herein. For example, it may set the availability, sequence, or arrangement of cards, graphical elements, or other features, as noted above.

In some implementations, at 308, the demo deck manager 232 may load features for one or more of the set of module cards for the identified second user. For instance, using the identified user profile, the demo deck manager may retrieve the settings, available modules, and any customizations based first user configuration and/or previous second user interaction. The functionality of each card may be dynamic to proceed through its functions. For example, the demo application 108 may track progress by the user through the steps of a demo path or sequence of demos or based on automated customization of the demo path for the user.

As noted elsewhere herein, the progress percentage or the passage of certain conditions (e.g., interaction with a certain graphical element, viewing a certain page of a digital demonstration) may provide a trigger in a defined rule, where the action includes displaying, enabling, arranging, or modifying one or more other cards in the demo deck. For instance, within a first card, a user may proceed through a fully or partially guided demo and, when the user passes a certain point, a separate card in the demo deck may be displayed and enabled for user interaction. For example, the triggering step in a demo in the first card may describe interaction with a certain feature of a product, and a second card that provides code or, potentially interacts with a third-party server 118 associated with that product, may be enabled thereby allowing the user to test the functionality. Other examples are possible and contemplated herein.

In some implementations, each user, role, or organization may have a dynamically (as noted above) or pre-configured demo deck in a container, so that each of the modules/tools/cards/demos are automatically customized to that identified user/role/organization while remaining separate from those of other users/roles/organizations. As noted elsewhere herein, the demo deck container and/or its interfaces may be served by a server via a web browser or dedicated application to the second user's client device 106, whether it's a desktop computer, laptop computer, tablet computer, mobile phone, or XR device.

In some implementations, at 310, the demo deck manager 232 may receive user input from the second user selecting an operation or feature of a first card. In some implementations, at 312, the demo deck manager 232 may update the graphical representation of first card based on the loaded feature(s) and user input. For example, depending on the type/coded functionality of the card, it may be customized based on the second user's profile, displayed based on the second user's inputs and/or the first user's configuration, and its code, cache, functionality, etc., and/or it may be updated based on the second user's input. Example details of the cards, available options, features, and interactions are described in further detail elsewhere herein, for instance, in reference to the example graphical user interfaces.

As an example, a second user may select a graphical card in a graphical user interface, which card may be one of multiple possible cards allowing interaction with demos, tools, or other modules. For instance, the user may select a card that allows interaction with an LLM chat bot that has access to the demo, such as portions of the demo and demo deck already released to the second user, organizational data, details about the demo player or application, or other information. The AI chatbot card may provide a set of example prompts that may be clickable, which may represent, for instance, frequently asked questions (FAQs) or questions automatically generated using the LLM (or by the first user) based on the second user's progress, role, or interests. When the user selects a recommended prompt, the demo application 108 may transmit the prompt to the AI agent, which uses the prompt along with any accompanying context (e.g., defined by an administrative user or first user), such as information selected describing the second user, the second user's progress, demo card features, or other data relative to features, such as those described herein. Additionally, or alternatively, the second user may interact with the AI chatbot through a chat interface or other inputs/outputs.

In some cases, the selection of the example prompts or interaction of the second user with the AI chatbot card may cause progress of the user through the features of a particular demo or of the demo deck, which automatically triggers additional cards or features to be unlocked. For instance, if the user asks about a certain feature, the AI chatbot may surface or generate an additional card that is displayed to the user, so that the user can demo a certain feature or gain certain functionality, such as an ROI (return on investment) calculator, which may be pre-loaded with the second user's (or organization's) data.

For instance, the demo application 108 may include function calling where functions or other structured prompts and response parsing are used in the same or separate message and/or response. For example, the demo application 108 may list other available tabs, criteria for activating the tabs, and allow the AI to provide a structured response that, when parsed by the demo application 108, causes the demo application 108 to activate the corresponding card or other functionality. In other implementations, merely selecting a recommended or pre-set prompt may serve as the progress trigger that activates another card, demo, or functionality. Thus, interaction with the AI via chat in a given card may automatically change the behavior of the demo deck graphical interface and/or cards or other features within it.

As the user interacts with a card, its visual appearance or other state (e.g., between hidden and visible) may be updated. For example, chat messages may be shown in a chat card, calculations may be shown in a calculator card, or otherwise. In some cases, a card may provide interfaces with various websites, software modules, or otherwise that improve the user experience and understanding of the demonstrated item. Some cards may be scrollable horizontally or vertically or may have multiple pages or images that can be flipped through on the graphical user interface. Other example cards, features, and operations are described in further detail elsewhere herein.

As noted elsewhere herein, additional cards may be displayed based on defined interactions with the displayed set of cards. Similarly, although only one instance is described the user may interact with multiple cards or a single card multiple times (with the demo deck manager storing its state each time). Additionally, when a card is opened or interacted with, the demo deck manager may display a popup, new window, or redirect to another page.

In some implementations, at 314, the demo deck manager 232 may receive a user input selecting demo card from among deck of cards. The demo deck may have a single card leading to multiple demos, multiple cards each leading to a single demo, or a combination. A demo (e.g., via a demo player) may be displayed entirely within a demo card graphical element, may surface another window or direct to another page, or a combination, depending on the demo. As noted elsewhere herein, a demo may include a digital demonstration that includes a set or series of demonstration elements, which may be text, video, audio, images, or interactable elements, such as software or replicated functionality of software. Thus, the digital demonstration may provide a guided or partially guided path through graphical elements, which may include back-end logic (e.g., for display, etc., as noted elsewhere herein), describing a product or otherwise.

In some implementations, at 316, the demo deck manager 232 may determine a set (e.g., a group or sequence) of demos or demo elements for user based on user input. For example, the first user may define a demo path for the second user in which the user proceeds through one or multiple demos. In some cases, the demo deck manager may determine interests of the user and then automatically determine a set of demos or a sequence thereof (potentially within a set or framework set by a first/sharing user). For example, a user may fill out a questionnaire of most to least relevant or interesting topics and the demo deck manager 232 may select the most relevant demos and automatically sequence them from most to least relevant. Additionally, or alternatively, if the user has previously interacted with the demo card, if a first user has defined it, or otherwise, the demo deck manager 232 may accordingly select one or more demos (e.g., digital demonstrations available within or across cards).

In some implementations, at 318, the demo deck manager 232 may display a demo player for set/sequence of demos/demo elements. In some implementations, selection of a demo card may display a graphical page showing a demo player and allowing the user to review a demo or path/sequence or other set of demos or portions/elements of demos. The demo(s) may include multimedia, software, and/or a representation of software, for example, to demonstrate software, a product, or features thereof. Additional details of the demo card and customization of demo(s) are described in further detail below.

In some implementations, at 320, the demo deck manager 232 may receive a share request from second user to share a card, demo, demo element, or deck, with a third user. For instance, based on an interaction by the second user with one or more cards or with one or more demos within or accessed from a demo card, the demo application 108 may present a sharing interface via which the second user may elect to share one or more of the particular demo/demo element and the demo path with a third user. For example, as the second user progresses through a path/sequence of demos, they may determine to share it with a third user and may select a sharing button and enter the third user's information. In some cases, the second user takes the first user's role respective to the third user, or the first user may remain the administrative or controlling user.

In some implementations, at 322, the demo deck manager 232 may associate the defined demo or demo element with a third user. For example, if the second user selects a certain demo in a sequence of demos when sharing, the demo application 108 may record that location so that the demo or demo element may be automatically associated with the third user in data storage. Thus, by forming this association during sharing, the demo application 108 may start the third user's graphical user experience at that point or otherwise graphically distinguish it to the third user.

In some implementations, at 324, the demo deck manager 232 may automatically adjust a sequence of demos/demo elements based on the association and an identification of the third user. For example, when the third user selects the shared link and/or logs in, the demo path may automatically begin with the demo (or demo element, card, etc.) shared by the second user, though the demo deck manager 232 may also display some or all of the other demo elements, demos, cards, etc., potentially in a sequence or path defined by the first user. The shared demo may be moved to the start of the path, or the path may automatically start at the shared demo on the path, although other implementations are possible. Accordingly, when the third user logs in, the demo application may usher customize the user interface to directly navigate the third user to the track (e.g., path or sequence) and/or point in the track shared by the second user. They may also be able to navigate out to the demo deck to view and use the tools in the deck, which may be reset to the initial available set, to those tools available to the second user, separately defined (e.g., their display, availability, or other state) by the first user, or otherwise.

In some implementations, at 326, the demo deck manager 232 may, based on first user and/or second user interactions, modify the available set of module cards for the second user. For example, as the second user progresses through the demo path(s) and/or interacts with different cards, they may satisfy defined criteria, which triggers the demo deck manager 232 to unlock and display one or more additional cards and/or demos (whether within a path of a previous card or in separate cards). Additionally, or alternatively, the first user may monitor progress of the second user's interactions with the demo(s), demo elements, and/or cards and may manually release additional cards, which may have additional functionality and/or demos (e.g., of other aspects of a product). In some cases, the first user or the second user may similarly release functionality to the instance of the demo application 108 of the third user.

For example, at 328, the demo deck manager 232 may load and display an updated set of available module cards in the graphical user interface to the second user. As the cards in the deck are unlocked by first or second user action or based on other criteria (time period, organizational preferences, automated processes, etc.), the demo deck manager 232 may customize the modules associated with the enabled tools/cards for the second user, and it may display graphical representations of the cards in the deck.

It should be noted that other operations, orders, and features are contemplated herein. For instance, the technology may use fewer, additional, or different operations or orders of operations than those described herein without departing from the scope of this disclosure. It should be noted that although the operations of the method 300 are described in reference to the demo application 108, they may be performed by different components of the system 100, distributed, or otherwise modified without departing from the scope of this disclosure.

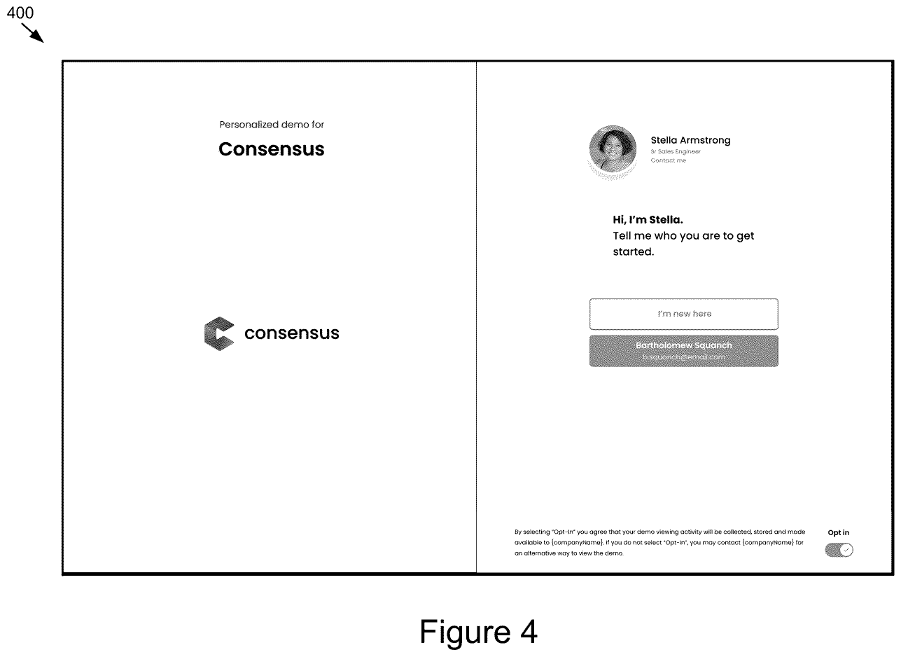

FIGS. 4-21 illustrate example graphical user interfaces for intelligently generating, updating, and providing a dynamic deck of digital demonstration module cards and associated functionality, for example, as provided by the demo application 108. While certain interfaces and features are shown and described, these are provided only by way of example and others are possible and contemplated herein.

FIG. 4 illustrates an example login interface 400, which indicates the identity of a first user and also allows a second (or third, etc.) user to start a new profile or sign in to an existing profile. Other demo, first user, second user, organization, etc., data may be illustrated, for example, based on the identification of the first user, second user, etc., such as using web cookies, a shared link, a login, or otherwise. In some implementations, images, text, or logos may be automatically replaced based on the first or second user's organization or other details.

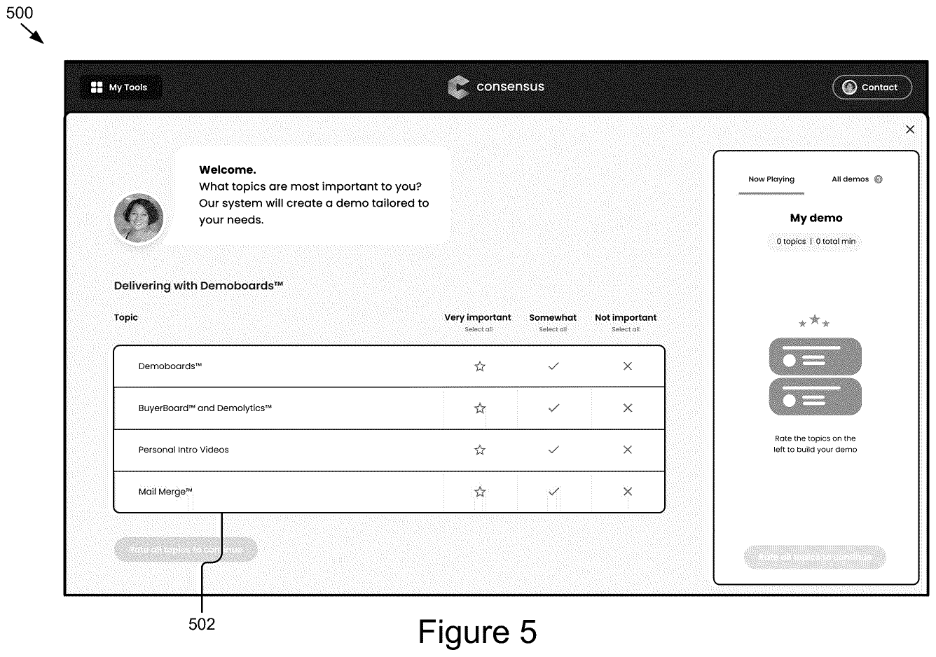

FIGS. 5-8 illustrate an example preference selection for a demo path of a second user. For example, the example interfaces allow a second user (or a first user, third user, etc.) to select certain preferences that are most relevant for the second user, which the demo application 108 may use to customize the demos/tours, demo deck, cards, or other elements.

FIG. 5 illustrates an example interface 500 that may be displayed upon selection, for a first time, of a demo card in a demo deck. As noted elsewhere, a user may redefine these preferences at a later point. A list 502 of topics may be shown and a user may select a level of interest or importance. In the illustrated examples, a user may select whether certain product features or other topics are very important, somewhat important, and not important, and the demo deck manager may automatically find, sort, and sequence the demos of the topics into a path of demos or demo elements (e.g., videos, tours, etc.).

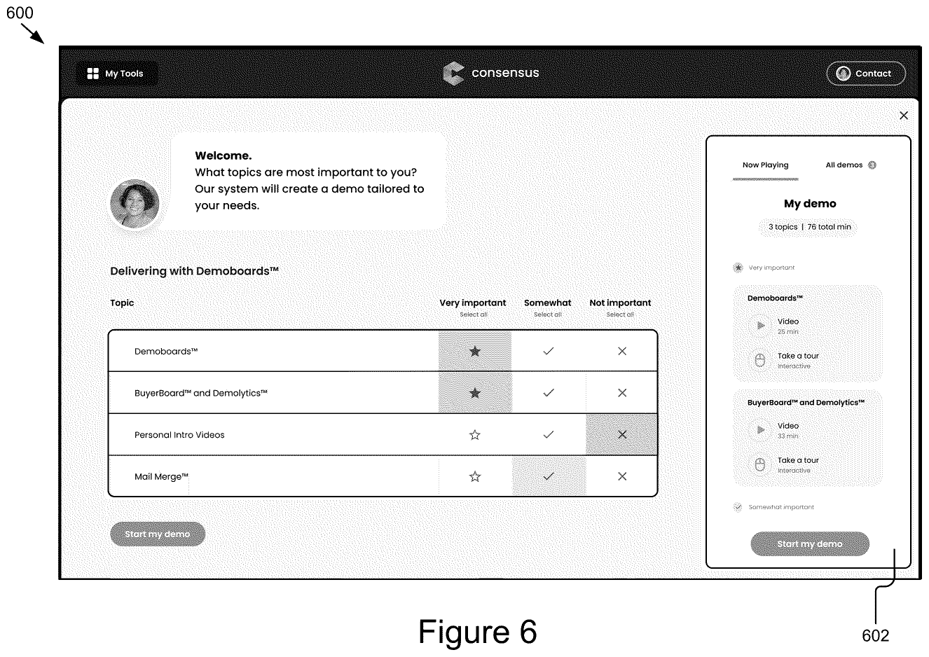

FIG. 6 illustrates an example interface 600, which may be displayed after the user selects the importance levels for various topics (e.g., from FIG. 5). The path of demo elements may be displayed in a now playing sidebar 602. The sidebar 602 may display the path or sequence of demos, which may each include one or more demo elements digitally demonstrating various features. The length or detail of each demo, such as the number of demo elements, whether the demos include media segments, and cards, tools, or other functionality enabled by the path of demo elements. For instance, various demos may include varying levels of detail where greater detail demos are associated with increased interest while lower detail demos are associated with decreased interest. Accordingly, the interfaces and tools may be customized to a user in a way that reduces computational resources, bandwidth, storage space, or other computational resources by tailoring the detail and functionality to what is needed for a given context.

In some implementations, cards may be associated with certain demo elements of a demo. As a user interacts with those demo elements (buttons, chats, hotspots, media segments, etc., as noted elsewhere herein), the demo application 102 (e.g., the demo deck manager 232) may use the interaction as a trigger to modify the demo deck, such as by displaying or enabling a card. Because tours with decreased interest or importance may have decreased detail, they may also have fewer cards associated with/enabled by them. Thus, in some implementations, the actual code and functionality of the demo and triggered by a demo may automatically adjust to the context and user. Accordingly, in these and other implementations, the efficiency of the file and execution is improved, and latency may also be reduced over circumstances where all possible cards are used.

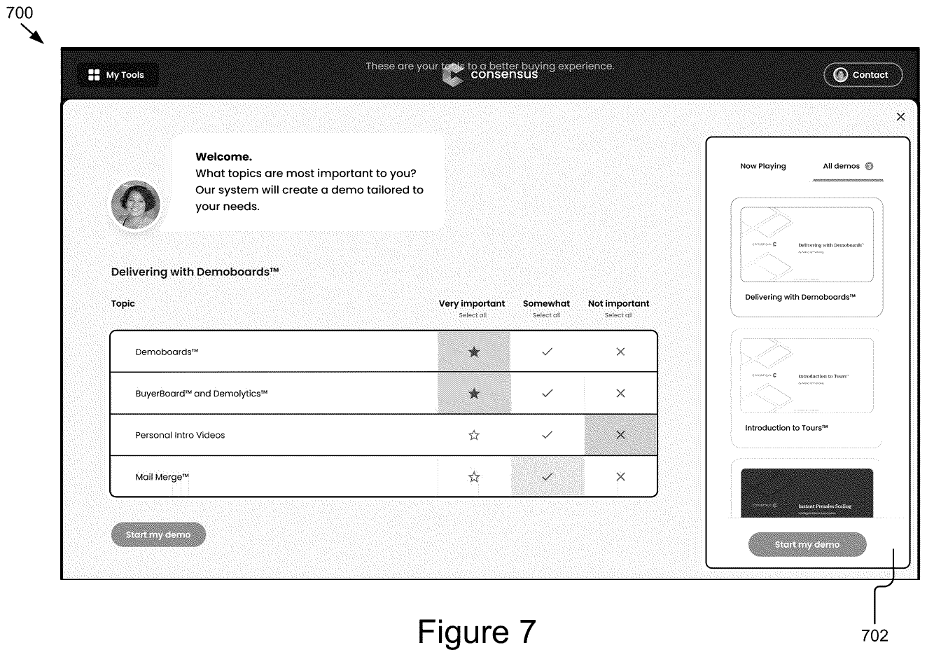

As illustrated in the example interface 700 of FIG. 7, in some implementations, the sidebar 702 may be selected by the second user to display a set of demos, which may show all demos for the user. The demos may be ordered based on the second user preferences or first user configuration, and they may indicate a current demo, new demos, etc. In some cases, a new questionnaire may be displayed for each demo in the list.

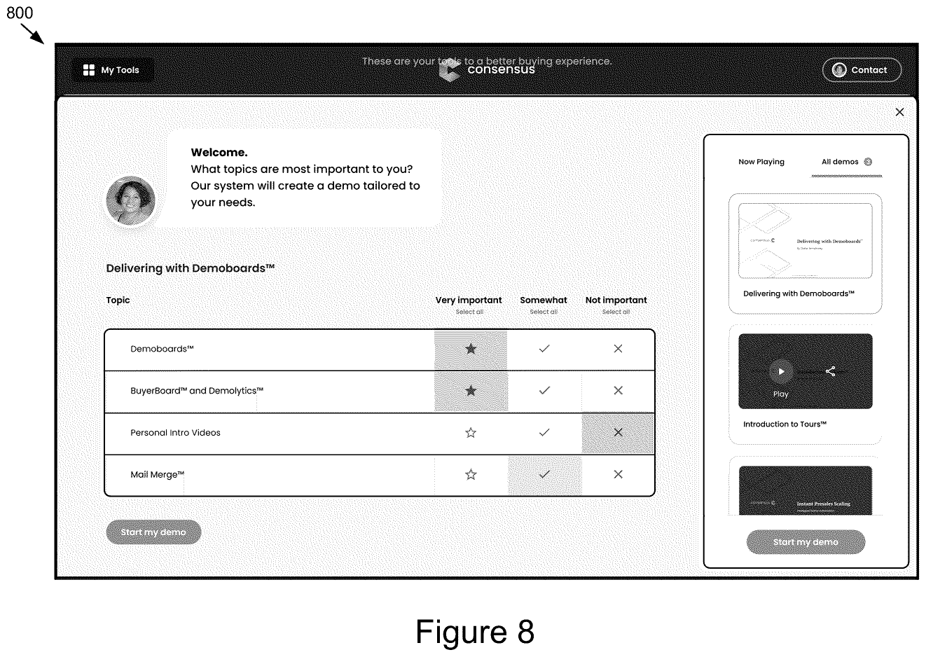

FIG. 8 illustrates an example interface illustrating interactions with graphical representations of the demos in a set of demos. In some cases, the second user may select a demo from the list of demos and play it out of order, or it may automatically be selected. Similarly, from the list of graphical elements or thumbnail images representing the demos, the second user may share a particular demo, as noted above, with a third user.

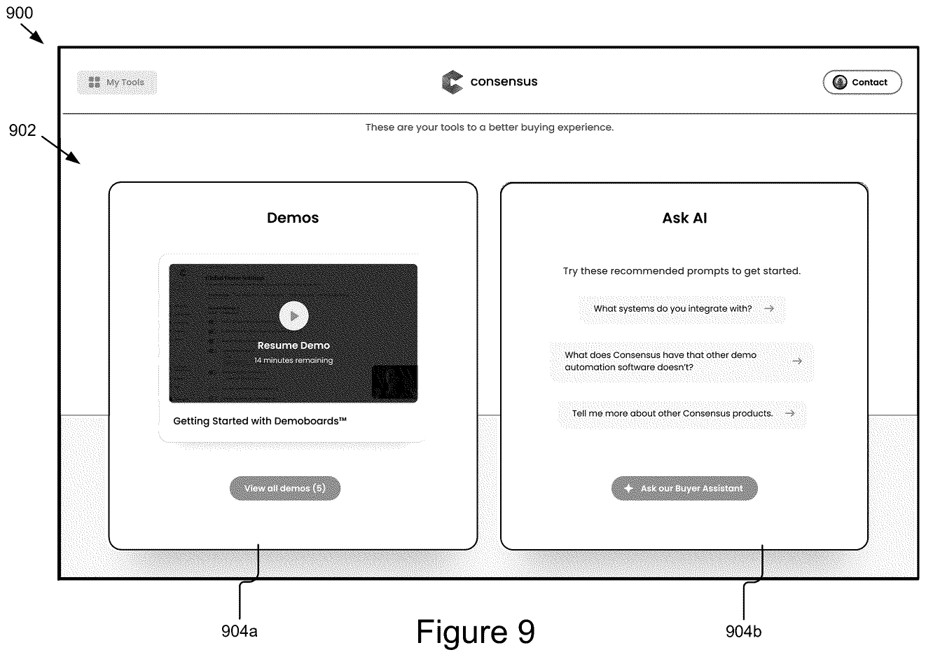

FIGS. 9-11 illustrate various interfaces of an example container, board, or demo deck of module cards (e.g., showing graphical representations or cards representing, linking to, and/or allowing interaction with demos and/or tools). As noted above, a demo deck may provide a configurable set of tools to a second user, such as where the second user is experiencing a digital demonstration of a product, which deck may have various arrangements (based on implementations, client device display size or aspect ratio, etc.), though it is displayed as a 2 column grid of graphical cards that expands as cards are added. In some cases, the demo application 108 may zoom the interface out to display a larger grid of cards. Each card in the grid may allow interaction within the card as it displayed in the deck, and/or it may be selected to open another window, frame, or page for that tool.

Depending on the implementation, a demo deck may include, be, or represent a guided toolbox where modules can be housed. It may include a receptacle for fanning out ideas and tools-visibilities of which may be controlled/guided by a sharer who can select which tools are available, their functionality, etc., as noted elsewhere herein. Each card in the deck may represent different functionalities and/or demos, which may be loaded with features for the buyer to consume. The tool cards may be modular and straightforward with graphical representations fanned or laid out for the second user, for instance, in a guided faction.

While some interfaces provided a splash page where a user is overloaded with information, implementations of the interfaces described herein allow a new user to become accustomed to the interfaces and not distracted from the demoed products, while the demo application 108 also intuitively customizes the interfaces to the particular circumstances of the user, organization, and/or computing device, as noted elsewhere herein. Similarly, none of these previous interfaces allowed the guided graphical user experiences, such as those examples provided herein, that guide users through discovering, learning, and using tools and other demos.

A card may be a dynamic graphical element within which functionality may be provided to the second user (and/or other shared users). The card may provide dynamic functionality within the graphical representation in the deck, and its representation may be updated and/or may maintain interaction as the second user interacts with it. Although, it should be noted that, in some implementations, a card may include a static link to another page, such as a demo path.

As noted elsewhere herein, some of the cards may provide or lead the second user to one or more demos, demo elements, demo paths, or interest questionnaires. Depending on the implementation, various cards may also include one or more chat interfaces between a first and second user, between a second and third user, between a second user and an AI chatbot, etc., as noted elsewhere herein. In some instances, a card may include one or more RFP (request for purchase) tools for the product(s), an ROI (return on investment) calculator (e.g., with statistical financial graphs defined by the first and/or second user), or other functional modules/tools associated with a demo. Although several examples are provided, the cards may include various functionality, demos, or otherwise that may be customized and intelligently provided.

FIG. 9 illustrates an example graphical interface 900 including example initial demo deck 902 showing two example cards 904a and 904b. An example demo card 904a may provide a built-in demo player (e.g., displaying media or allowing interaction with interactable elements), a link to a demo path, a link to a list of demos, or other details. An example chat interface card 904b may allow the user to select suggested prompts (e.g., as noted above) or otherwise interact with an AI chatbot. The AI chatbot may include an LLM-powered service using retrieval augmented generation or another technique for accessing a database and responding to questions by users, such as questions about the demo deck, the demo application, features of the demo or product, or otherwise. In some implementations, the data to which the AI has access may be automatically increased/changed based on the available demos or cards, so that the AI only answers questions about the available cards, although other implementations, such as where the AI has access to all the data are possible. Furthermore, in some implementations, the AI may be multi-modal and may automatically determine information about the demos and/or cards by reviewing their text, images, videos, or logic/code in order to automatically parse and determine answers to user prompts.

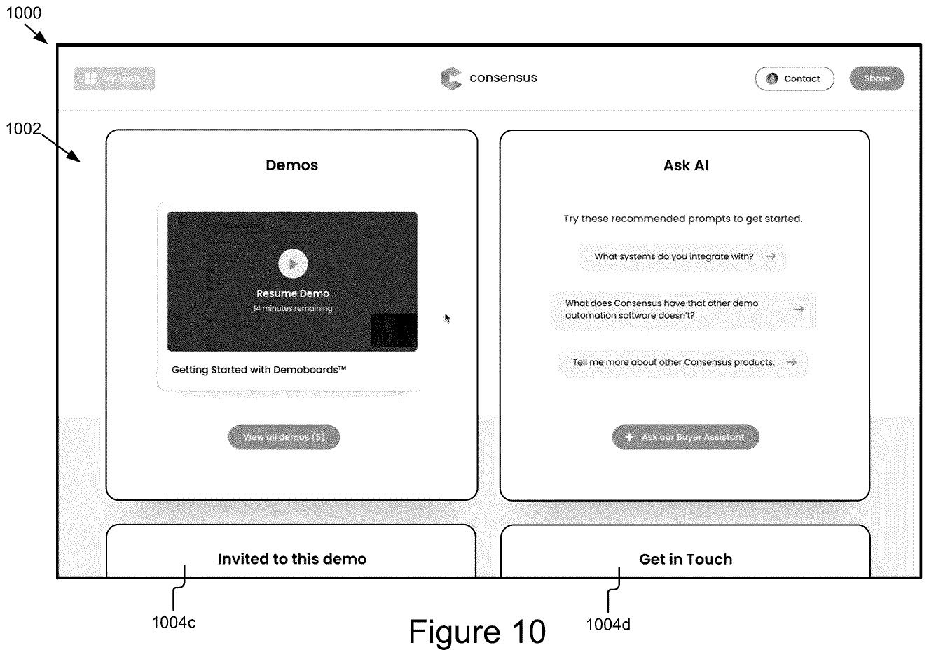

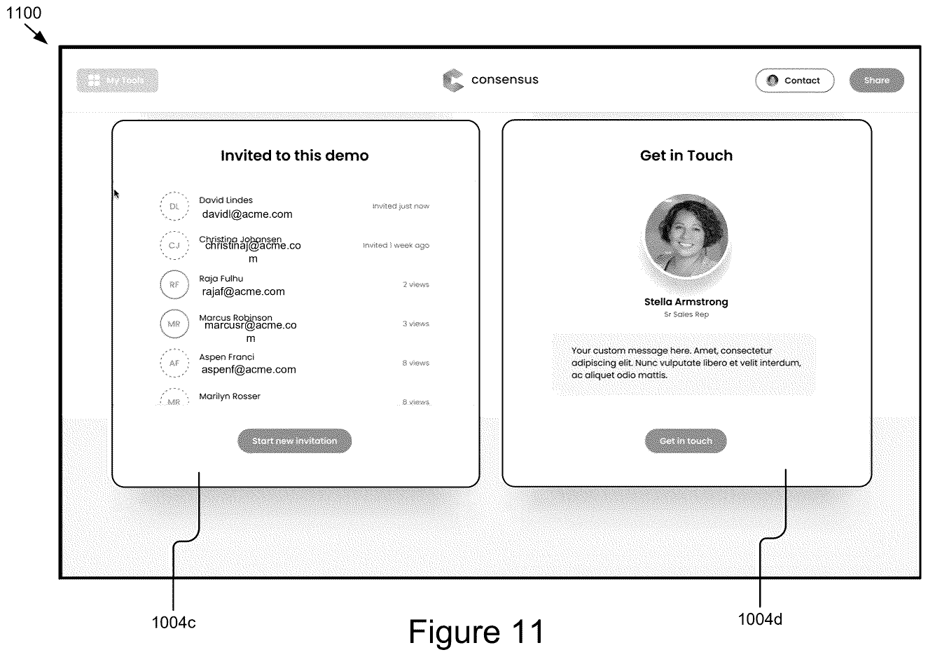

FIG. 10 illustrates a graphical interface including an example demo deck 1002 in which additional cards 1004c and 1004d have been released and are displayed to the second user. For instance, the cards may be displayed in a scrollable grid that allows the user (e.g., the second user) to view and/or interact with the cards. FIG. 11 illustrates a graphical interface 1100 including a scrolled down view of the demo deck 1002 of FIG. 10. As shown in the example figures, a first card 904a may include a demo, a second card 904b may include an AI chat interface, a third card 1004c may indicate the users with whom the demo and/or demo deck has been or may be shared (e.g., by the first user, second user, and/or third user) and potentially their progress, and a fourth card 1004d may allow the second user to contact (e.g., via an email or direct chat/contact) the first user.

Other graphical elements may also be shown, such as a contact button, a link to tools (e.g., the demo deck), a sharing button, or otherwise. Additionally, a demo deck may include customizations, logos, images, or otherwise for the second user's organization, the first user's organization or product, or otherwise, as noted elsewhere herein.

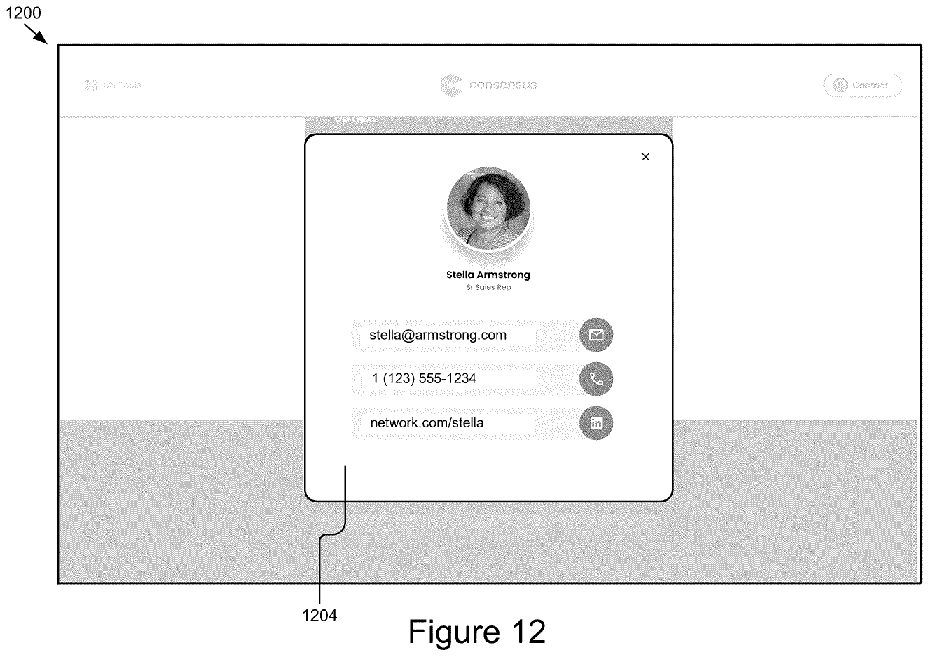

FIG. 12 illustrates an example interface 1200 with a card 1204 displaying information and links for contacting the first user, although a direct chat, meeting, or otherwise accessed or used within the card 1204 may additionally or alternatively be used. The card 1204 of FIG. 12 may be surfaced upon selection of a contact button in a contact card (e.g., 1004d). In some cases, the contact button may surface a contact card/interface in an overlayed image, window, or separate page, or it may replace the graphical elements shown in the card 1004d.

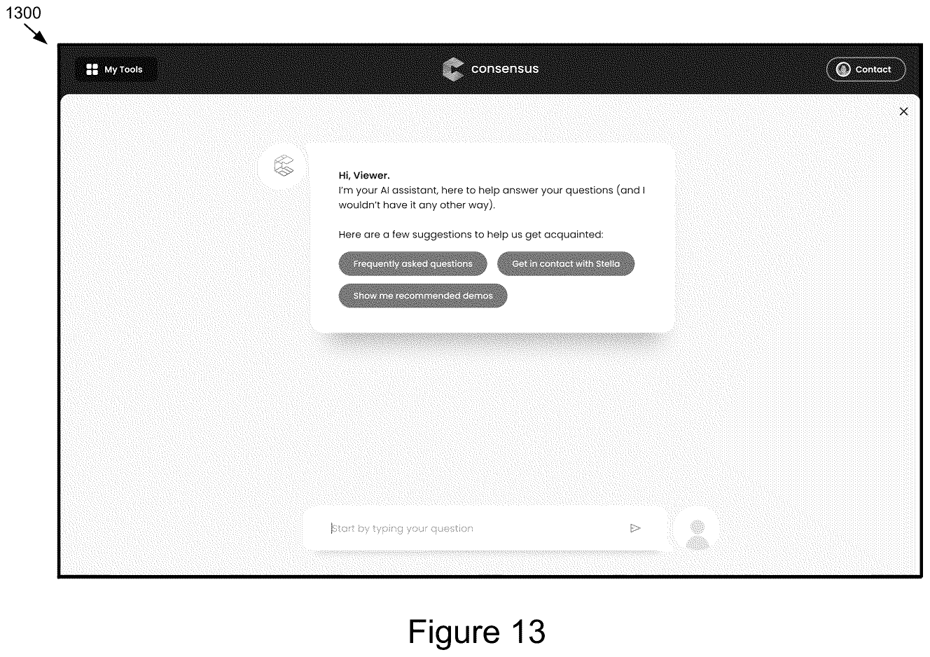

FIG. 13 illustrates an example AI chat interface 1300, which may be displayed when the user interacts with an AI chat card (e.g., 904b), selects a help button, or expands the AI chat card, though other implementations are possible and contemplated. Additional features and details of an AI chat interface are described above. As noted elsewhere herein, in some cases, various proposed prompts may be provided. The prompts may be defined by an administrator or other user. In some cases, the prompts may be automatically recommended (e.g., by the AI model) based on progress of the user through the demos, information being viewed by the user, or other details. As noted elsewhere herein, in some cases, interacting with a chat card or recommended prompt may be a trigger to display or enable other cards or demo features.

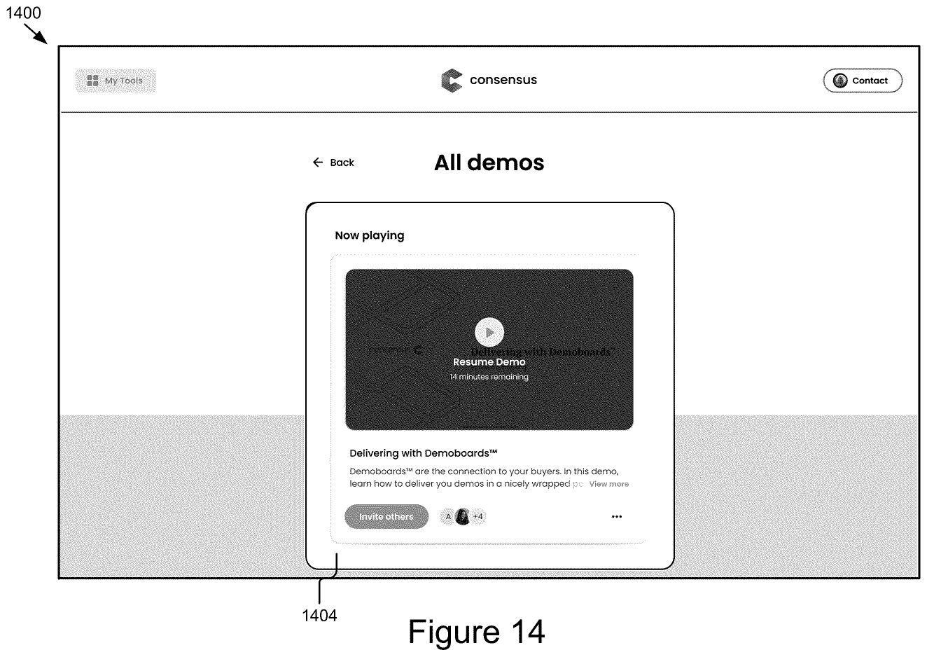

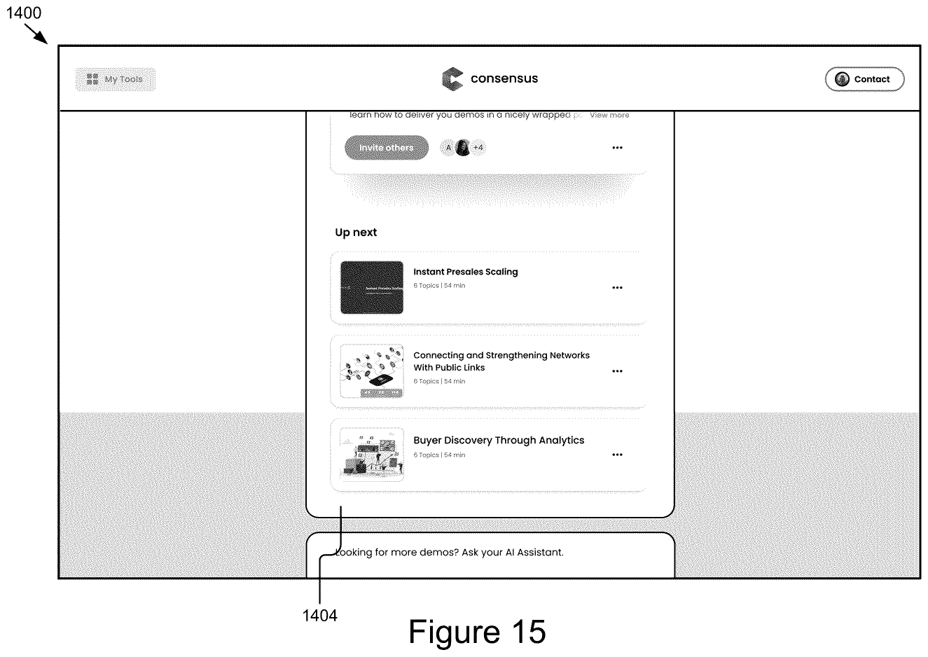

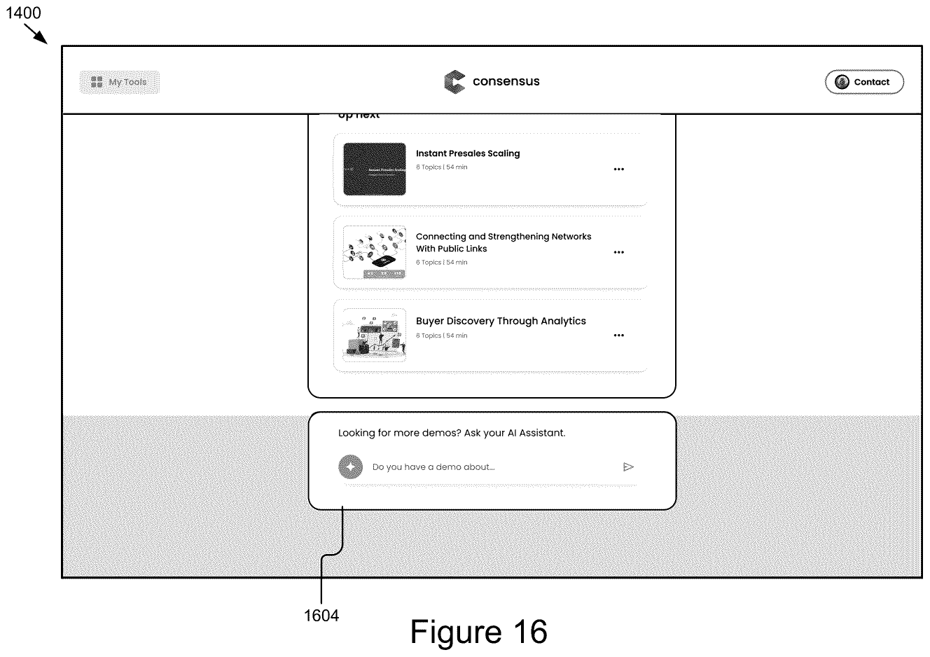

FIG. 14-16 illustrate example interfaces for accessing and using a demo, such as in a demo player. FIG. 14 illustrates a graphical interface 1400 including a card 1404 showing a demo with a demo player, sharing information, etc., which can be selected to view the demo either in the card or in full window. In some implementations, a demo card (e.g., 904a) in a demo deck may be selected to display a list of demos, such as in the interface 1400 of FIG. 14, which interface 1400 may provide a scrollable list showing the set and/or sequence of demos, their current status, their sharing status, or other information. FIG. 15 and FIG. 16 show the example interface of FIG. 14 scrolled down. For instance, in a first demo element, a demo player may be displayed and, below it, next elements of the demo may be illustrated (e.g., next demos, topics, videos, durations, menu elements, etc., may be shown). In some cases, another representation of a demo may be shown along with its demo elements, durations, demo player, etc. As illustrated in FIG. 15, a particular card 1404 may have an increased length to provide additional information. For instance, it may expand as the user scrolls to provide additional information about the demo or demo path.

As illustrated in FIG. 16, another element, such as a card 1604, may be shown allowing the user to interact with an AI chatbot about the demo(s) or about whether there are any demos for other topics or products. As noted elsewhere herein, the AI chatbot may allow the second user to access another demo or demo card; request permission from the first user to display another demo, demo card, or demo element; or may automatically generate a demo using generative AI.

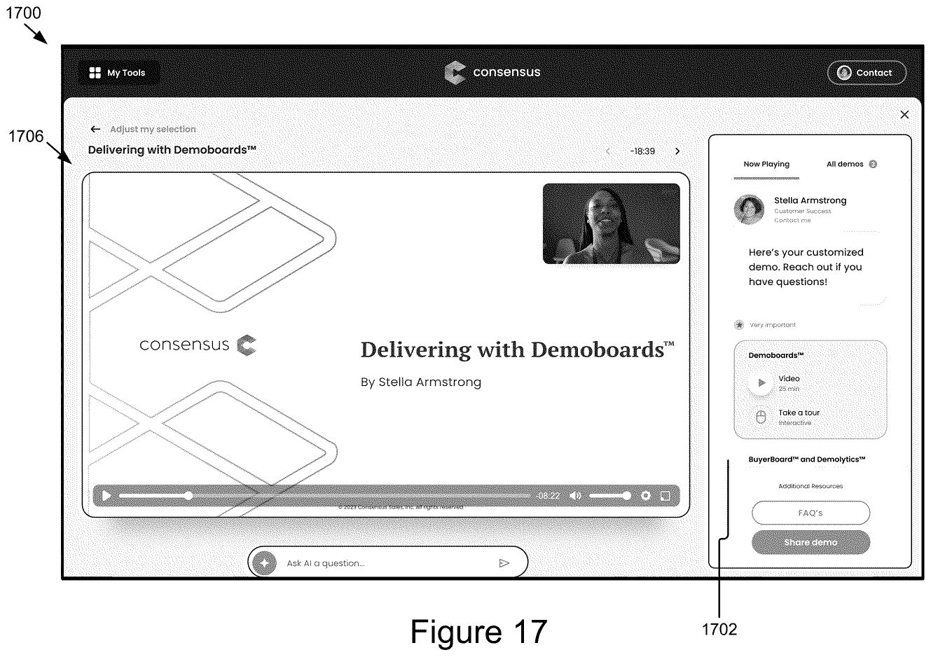

FIGS. 17-20 illustrate examples of one or more demos, for example, in a demo player. For example, a demo player may provide media, software reproductions, step by step guide(s), a click through tour, slides, or other demo elements or details for one or more demos. FIG. 17 illustrates an example interface 1700 in which a media region 1706 is shown alongside a sidebar 1702 that provides an indicator of progress and an interface for navigation through digital demonstrations, as noted elsewhere herein. As shown in the example of FIG. 17, a demo element includes a video playing in the media region 1706. The demo may have multiple demo elements relating to multiple topics (e.g., based on the user preferences), as illustrated in the now playing bar of the sidebar 1702, so the user can see which demo elements (e.g., media elements, tours, videos, etc., describing different topics) preceded and/or are subsequent to the currently displayed demo element.

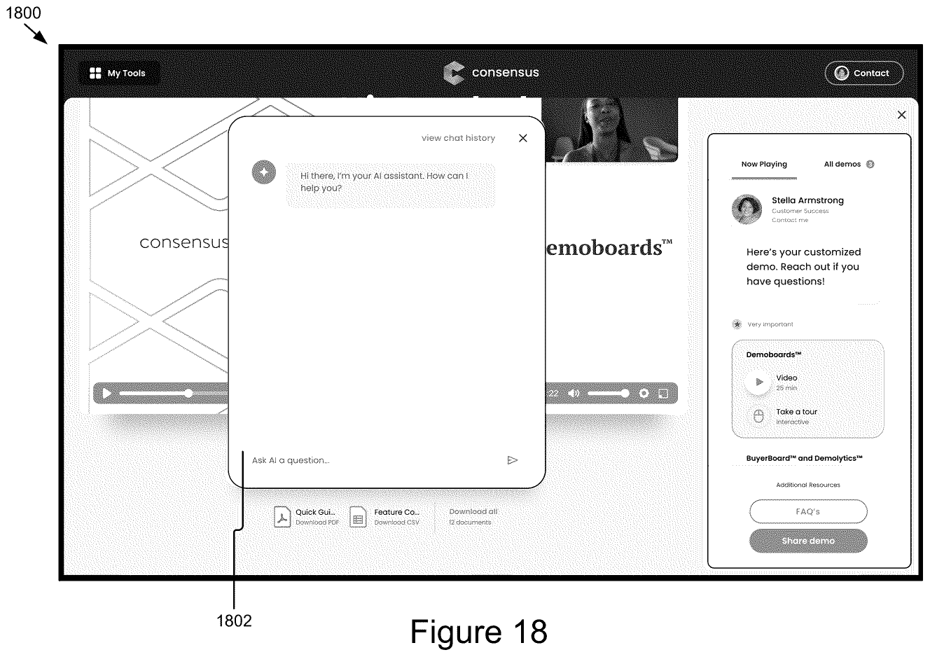

FIG. 18 illustrates an example interface 1800 in which the demo deck manager 232 may surface a chat interface 1802 with the first user and/or an AI chatbot at any point. In some implementations, the demo application 108 may capture an image of the interface or current point in the demo player and include it with the prompt to the AI chat bot. In some cases, the demo application 108 may also provide some or all of the demo (e.g., images, video, a transcript, embeddings, etc.) or other data. Accordingly, the demo application 108 may provide a well-structured prompt that improves the quality of the AI response.

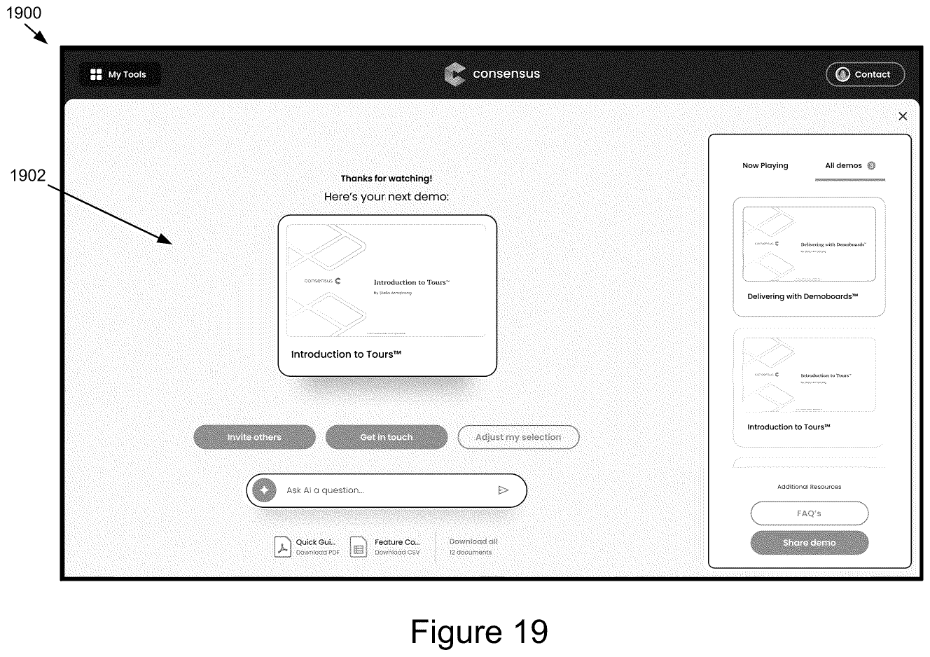

FIG. 19 illustrates an example interface 1900 including an example demo player 1902. As shown in the example, once the user completes a certain demo, they may proceed to a subsequent demo, check FAQs, share the demo, view or download documents for the demo or otherwise.

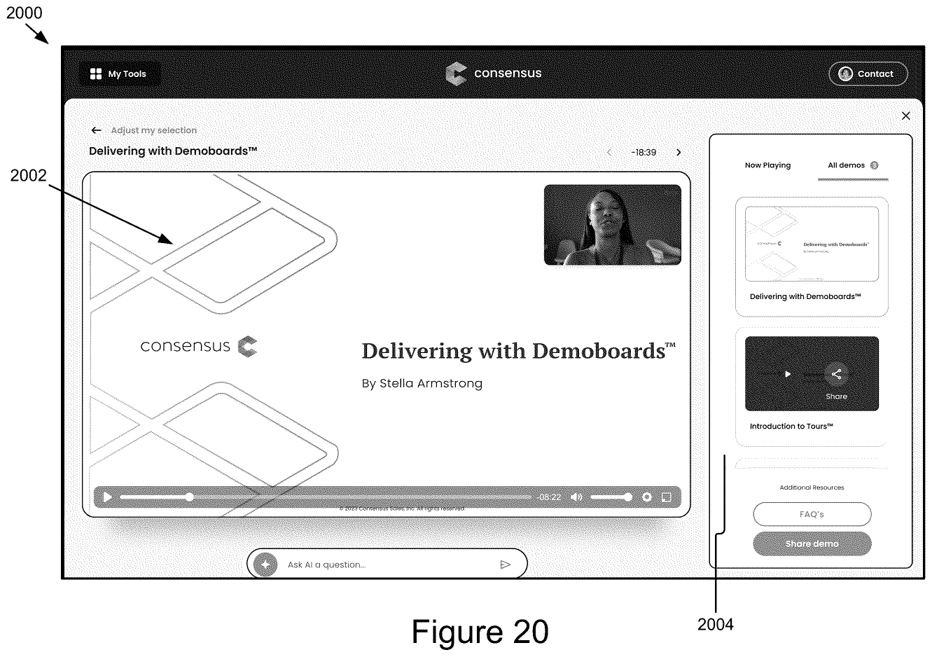

FIG. 20 illustrates an example interface 2000 including an example demo player 2002 and includes a side bar 2004 in which all or a subset of demos are listed for the second user. Each graphical representation of a demo (and/or a demo element) may include a share element responsive to the selection of which the second user (potentially configured by the first user) may share the demo path, demo, demo deck, card, or demo element with a third user. In some implementations, the demo application 108 may store and use the demo element, etc., from which the share request was received and use it to determine the initial element to display to a user with whom it is shared. For instance, the demo application 108 may first display the demo element from which it was shared with a third user when the third user accesses the demo application 108 (e.g., regardless of whether the second user has proceeded past that point in the demo(s)).

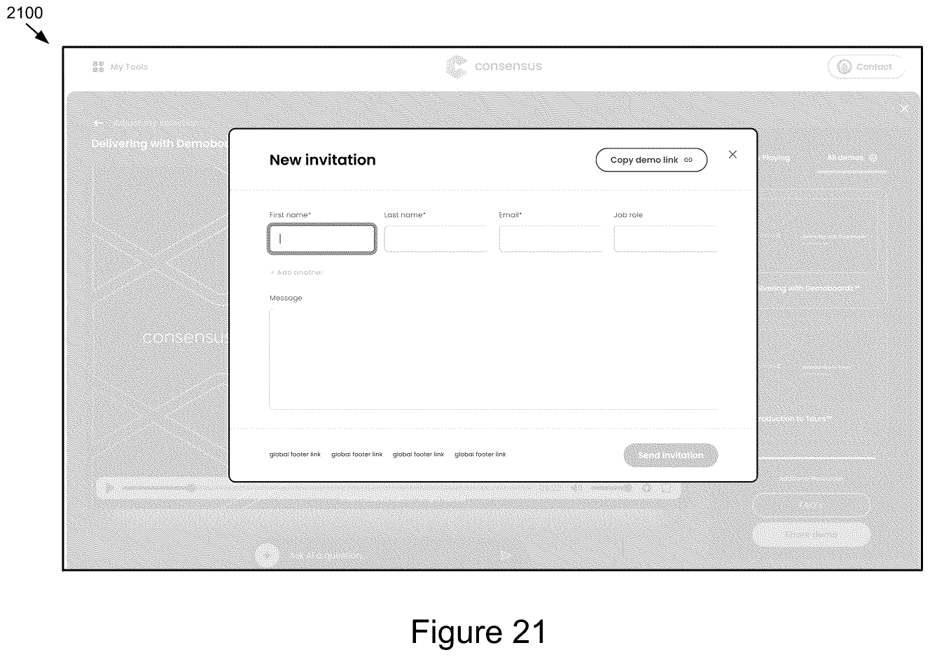

For example, responsive to receiving an input selecting the share element, the demo application 108 may display the example interface 2100 of FIG. 21, which allows the second user to share with a third user. Based on the selected sharing element, any additional details provided by the first or second users, a job role, or other information, the demo application 108 may determine a demo path and/or demo cards in a demo deck to share with the third user. Based on this information, the demo path may be pre-configured for the third user. As noted above, the demo application 108 may automatically provide the associated/shared demo to the third user first.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

To ease description, some elements of the system 100 and/or the methods are referred to using the labels first, second, third, etc. These labels are intended to help to distinguish the elements but do not necessarily imply any particular order or ranking unless indicated otherwise.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi^{TM}) transceivers, Ethernet adapters, and Modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions and/or formats.

Furthermore, the modules, routines, features, attributes, methodologies, and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A computer-implemented method comprising:
determining, by one or more processors, a set of module cards in a demo deck based on a first configuration for a first user;
determining, by the one or more processors, a set of features including a feature for each of the set of module cards, the set of features including at least one digital demonstration;
providing, by the one or more processors, a graphical interface depicting the set of module cards;
receiving, by the one or more processors, a first input from the first user interacting with a first module card of the set of module cards; and
updating, by the one or more processors, the graphical interface of the set of module cards based on the first input including modifying a graphical depiction of a second module card of the set of module cards.

2. The computer-implemented method of claim 1, wherein updating the graphical interface of the set of module cards includes:
changing a status of the graphical depiction of the second module card of the set of module cards from hidden to visible; and
allowing interaction with the second module card by the first user.

3. The computer-implemented method of claim 1, further comprising:
determining, by the one or more processors, a condition for enabling access to a third module card to the first user, the condition being defined by a second user; and
based on determining the condition for enabling access to the third module card, displaying the third module card in the graphical interface to the first user.

4. The computer-implemented method of claim 1, wherein:
the first input from the first user interacting with first module card includes an interaction with a defined demonstration element of the at least one digital demonstration accessed via the first module card; and
based on the interaction with the defined demonstration element, providing, by the one or more processors, functionality of the second module card in the graphical interface.

5. The computer-implemented method of claim 1, wherein:
the at least one digital demonstration includes a plurality of graphical demonstration elements organized into a sequence of steps, the first user interacting with the plurality of graphical demonstration elements during the at least one digital demonstration, the one or more processors tracking progress by the first user through the sequence of steps; and
the at least one digital demonstration is accessed via the first module card.

6. The computer-implemented method of claim 5, wherein:
the first input includes an interaction with a defined graphical demonstration element; and
modifying the graphical depiction of the second module card is based on the interaction with the defined graphical demonstration element, modifying the graphical depiction of the second module card changes a visual status of the second module card from hidden to displayed in the graphical interface showing the demo deck.

7. The computer-implemented method of claim 6, further comprising:
receiving, by the one or more processors, a second input from the first user including a second interaction with a second defined graphical demonstration element of the plurality of graphical demonstration elements; and
updating, by the one or more processors, the graphical interface of the set of module cards based on the second input including changing a visual status of a third module card of the set of module cards from hidden to displayed in the graphical interface showing the demo deck, the first module card providing access to a first function, the second module card providing access to a second function, and the third module card providing access to a third function.

8. The computer-implemented method of claim 1, further comprising:
receiving, by the one or more processors, a configuration of the demo deck by a second user, the configuration indicating access settings for one or more of the set of module cards;
receiving, by the one or more processors, a share request from the second user indicating to share the demo deck with the first user; and
providing, by the one or more processors, access to the demo deck by the first user subject to the configured access settings for one or more of the set of module cards.

9. The computer-implemented method of claim 8, further comprising:
receiving, by the one or more processors, a second share request from the second user to share one or more of the demo deck and the at least one digital demonstration with a third user;
recording, by the one or more processors, a location of the first user in the graphical interface when receiving the second share request; and
providing, by the one or more processors, access to the one or more of the demo deck and the at least one digital demonstration with the third user based on the second share request and the recorded location in the graphical interface.

10. The computer-implemented method of claim 1, wherein:
at least one module card of the set of module cards of the demo deck provides a chat interface, the chat interface providing interaction with an artificial intelligence agent including providing information to the artificial intelligence agent describing the at least one digital demonstration.

11. The computer-implemented method of claim 1, wherein:
the graphical interface of the set of module cards in the demo deck includes a grid of graphical representations of rectangular cards, each of the grid of graphical representations of rectangular cards providing a different functionality to the first user, each graphical representation of a rectangular card being enabled within the graphical interface based on a defined trigger.

12. A system comprising:
one or more processors; and
a computer accessible memory storing instructions that, when executed by the one or more processors, cause the system to perform operations comprising:
determining, by the one or more processors, a set of module cards in a demo deck based on a first configuration for a first user;
determining, by the one or more processors, a set of features including a feature for each of the set of module cards, the set of features including at least one digital demonstration;
providing, by the one or more processors, a graphical interface depicting the set of module cards;
receiving, by the one or more processors, a first input from the first user interacting with a first module card of the set of module cards; and
updating, by the one or more processors, the graphical interface of the set of module cards based on the first input including modifying a graphical depiction of a second module card of the set of module cards.

13. The system of claim 12, wherein updating the graphical interface of the set of module cards includes:
changing a status of the graphical depiction of the second module card of the set of module cards from hidden to visible; and
allowing interaction with the second module card by the first user.

14. The system of claim 12, wherein the operations further comprise:
determining, by the one or more processors, a condition for enabling access to a third module card to the first user, the condition being defined by a second user; and
based on determining the condition for enabling access to the third module card, displaying the third module card in the graphical interface to the first user.

15. The system of claim 12, wherein:
the first input from the first user interacting with first module card includes an interaction with a defined demonstration element of the at least one digital demonstration accessed via the first module card; and
based on the interaction with the defined demonstration element, providing, by the one or more processors, functionality of the second module card in the graphical interface.

16. The system of claim 12, wherein:
the at least one digital demonstration includes a plurality of graphical demonstration elements organized into a sequence of steps, the first user interacting with the plurality of graphical demonstration elements during the at least one digital demonstration, the one or more processors tracking progress by the first user through the sequence of steps; and
the at least one digital demonstration is accessed via the first module card.

17. The system of claim 16, wherein:
the first input includes an interaction with a defined graphical demonstration element; and
modifying the graphical depiction of the second module card is based on the interaction with the defined graphical demonstration element, modifying the graphical depiction of the second module card changes a visual status of the second module card from hidden to displayed in the graphical interface showing the demo deck.

18. The system of claim 17, wherein the operations further comprise:
receiving, by the one or more processors, a second input from the first user including a second interaction with a second defined graphical demonstration element of the plurality of graphical demonstration elements; and
updating, by the one or more processors, the graphical interface of the set of module cards based on the second input including changing a visual status of a third module card of the set of module cards from hidden to displayed in the graphical interface showing the demo deck, the first module card providing access to a first function, the second module card providing access to a second function, and the third module card providing access to a third function.

19. The system of claim 12, wherein the operations further comprise:
receiving, by the one or more processors, a configuration of the demo deck by a second user, the configuration indicating access settings for one or more of the set of module cards;
receiving, by the one or more processors, a share request from the second user indicating to share the demo deck with the first user; and
providing, by the one or more processors, access to the demo deck by the first user subject to the configured access settings for one or more of the set of module cards.

20. The system of claim 19, wherein the operations further comprise:
receiving, by the one or more processors, a second share request from the second user to share one or more of the demo deck and the at least one digital demonstration with a third user;
recording, by the one or more processors, a location of the first user in the graphical interface when receiving the second share request; and
providing, by the one or more processors, access to the one or more of the demo deck and the at least one digital demonstration with the third user based on the second share request and the recorded location in the graphical interface.
